(19) United States
(12) Patent Application Publication
(10) Pub. No.: US 2026/0055271 A1
(43) Pub. Date: Feb. 26, 2026

(54) FLAME-RETARDANT COMPOSITION

(71) Applicants: Mitsubishi Chemical Corporation, Tokyo (JP); FRX Polymers, Inc., Chelmsford, MA (US)

(72) Inventors: Hiroya ARAI, Tokyo (JP); Masahiro UEDA, Tokyo (JP); Xuidong SUN, Weston, MA (US); Peter LOUVARIS, Medford, MA (US)

(73) Assignees: Mitsubishi Chemical Corporation, Tokyo (JP); FRX Polymers, Inc., Chelmsford, MA (US)

(21) Appl. No.: 19/377,689

(22) Filed: Nov. 3, 2025

Related U.S. Application Data
(63) Continuation of application No. PCT/JP2024/017013, filed on May 7, 2024.
(60) Provisional application No. 63/500,182, filed on May 4, 2023.

(51) Int. Cl. C08L 69/00; C08K 3/32; C08L 83/04

(52) U.S. Cl. CPC C08L 69/00; C08K 3/32; C08L 83/04; C08L 2201/02

(57) ABSTRACT

The present disclosure provides flame-retardant compositions which may include polycarbonate or a polycarbonate blend, a phosphorous-containing flame retardant, and an impact modifier, wherein the flame-retardant composition exhibits enhanced impact properties and flame retardancy compared to the impact properties and flame retardancy of the composition without the impact modifier. Various impact modifiers are investigated herein.

### CROSS-REFERENCE TO RELATED APPLICATIONS

This application is a continuation application of International Application No. PCT/JP2024/017013, filed May 7, 2024, which claims the benefit of priority of the prior U.S. Provisional Patent Application No. 63/500,182, filed May 4, 2023, the contents of which are incorporated herein by reference.

### TECHNICAL FIELD

This invention relates to a flame retardant composition.

### BACKGROUND ART

Per- and polyfluoroalkyl substances (PFAS) are a large class of thousands of synthetic chemicals. They all contain carbon-fluorine bonds, which are one of the strongest chemical bonds known with high resistance to degradation and oxidation. They therefore break down very slowly in the environment. Scientific studies have linked high-level exposure to some PFAS to harmful health effects in humans and animals, and more research is ongoing to understand adverse health outcomes from exposures to PFAS.

The two PFAS used widely as flame retardants in thermoplastic plastic resins such as polycarbonate (PC) and its blends are polytetrafluoroethylene (PTFE) and Potassium Perfluorobutane Sulfonate (KPFBS). Companies like Apple have made commitment to phasing out the use of all PFAS from all their products, which necessitates the identification and development of non-PFAS alternatives that can meet the performance needs for critical applications, including the flame-retardant resins used in enclosures, cables, connectors and building products. Flame retardant PC and its blends are among these flame-retardant resins that currently utilize PTFE and/or KPFBS. For example, Patent Literatures 1 to 3 disclose flame-retardant PC resin compositions containing PTFE as an anti-dripping agent or a flame retardant aid.

### CITATION LIST

### Patent Document

Patent Document 1: International Patent Application Publication No. 2015/116509
Patent Document 2: U.S. Patent Application Publication No. 2016/0137836
Patent Document 3: U.S. Patent Application Publication No. 2017/0349746

### SUMMARY OF INVENTION

### Technical Problem

It is often encountered that when flame retardant is added to a plastic resin, the mechanical property such as impact property is compromised while flame retardancy is improved. To restore the impact property, an impact modifier is then added which in turn worsens the flame retardancy. This iterative process of balancing mechanical properties and flame retardancy with impact modifiers and flame retardants not only poses great technical difficulty (i.e., hard to get satisfactory result for both properties at the same time), but also adds materials cost to the product.

It has been particularly challenging to balance mechanical properties and flame retardancy of PC composition without anti-dripping agents such as PTFE. The present invention has been made in view of the aforementioned situation, and the object of the present invention is to provide a flame-retardant composition that shows excellent mechanical properties and flame retardancy that are balanced at a high level even without anti-dripping agents such as PTFE.

### Solution to Problem

Embodiments of the present invention are as enumerated below.

[1] A flame-retardant composition comprising:
polycarbonate or a polycarbonate blend, a phosphorous-containing flame retardant, and an impact modifier,
wherein the flame-retardant composition exhibits enhanced impact properties and flame retardancy compared to the impact properties and flame retardancy of the composition without the impact modifier.
   [1-1] The composition according to [1], which exhibits a flame retardancy of V-0 according to UL-94 and a notched izod impact strength of 800 J/m or more according to ASTM D256 at 3.2 mm.
   [1-2] The composition according to [1] or [1-1], wherein the proportion of the phosphorous-containing flame retardant is 20% by mass or more.
   [1-3] The composition according to [1] or [1-1], wherein the proportion of the phosphorous-containing flame retardant is 25% by mass or more.
   [1-4] The composition according to [1] or [1-1], wherein the proportion of the phosphorous-containing flame retardant is 30% by mass or more.
   [2] The composition according to any one of [1] to [1-4], wherein the composition is free of polytetrafluoroethylene (PTFE).
   [3] The composition according to any one of [1] (inclusive of [1-1] to [1-4], the same below) to [2], wherein the composition further comprises at least one additive selected from the group consisting of pigments, stabilizers, fillers, processing aids, and additional flame retardant compounds different from phosphorous-containing flame retardant.
   [4] The composition according to any one of [1] to [3], wherein the phosphorus-containing flame retardant comprises polyphosphonate, poly(phosphonate-co-carbonate), or combinations thereof.
   [5] The composition according to any one of [1] to [4], wherein the composition comprises the polycarbonate, and the impact modifier is of core-shell type and has a silicone content of 10% by mass or more.
   [6] The composition according to [5], wherein the impact modifier has a silicone content of 40% by mass or more.
   [7] The composition according to any one of [1] to [6], wherein the composition comprises the polycarbonate and the impact modifier is a polymer having a composite body and a graft part, the composite body comprises a polyorganosiloxane and a first vinyl polymer, and the graft part comprises a second vinyl polymer.
   [8] The composition according to [7], wherein the second vinyl polymer comprises a constitutional unit derived from a (meth)acrylate monomer.
   [9] The composition according to any one of [1] to [8], wherein the composition comprises the polycarbonate and 0.5% by mass to 10% by mass of the impact modifier.
   [10] The composition according to any one of [1] to [8], wherein the composition comprises the polycarbonate and 0.5% by mass to 5% by mass of the impact modifier.
   [11] The composition according to any one of [1] to [10], wherein the phosphorus-containing flame retardant comprises tetrakis(2,6-dimethylphenyl) 1,3-phenylene bisphosphate, bisphenol A bis (diphenyl phosphate) (BPADP), resorcinol bis(diphenyl phosphate) (RDP), resorcinol bis(2,6-xylyl phosphate), 4,4′-Biphenyl bis(diphenyl phosphate) (RXP), 1,4-phenylene bis(diphenyl phosphate), or combinations thereof.
   [12] The composition according to any one of [1] to [11], wherein the composition comprises polycarbonate blend, and the polycarbonate blend comprises PC/ABS, PC/ASA, PC/PBT, PC/PET, PC/PLA, or combinations thereof.
   [13] The composition according to any one of [1] to [12], wherein the composition comprises polycarbonate blend, the polycarbonate blend comprises PC/PBT or PC/PET, and the impact modifier is ethylene-methyl acrylate-glycidyl methacrylate terpolymer, or methacrylate butadiene styrene (MBS) core-shell copolymer.
   [14] The composition according to any one of [1] to [8] and [11] to [13], wherein the composition comprises 5% by mass to 10% by mass of the impact modifier.

### Advantageous Effects of Invention

The present invention can provide a flame-retardant composition that shows excellent mechanical properties and flame retardancy that are balanced at a high level even without anti-dripping agents such as PTFE.

### DESCRIPTION OF EMBODIMENTS

In the present specification, “% by mass” means a mass percentage based on the total mass of the composition of the present invention unless otherwise specified. Polytetrafluoroethylene (PTFE), a member of the PFAS family, has been widely used in flame retardant plastic compositions as an anti-dripping agent and has played an important role in imparting flame retardancy to the composition. PTFE fibrosis under the sheer force of the screw to form a network structure, thus playing a role in anti-dripping. It is very efficient even at low loadings, typically below 0.5% by mass, or below 0.4% by mass. To remove PTFE from a flame-retardant formulation would require the compensation of the flame retardancy from other venues to keep the same flame-retardant performance. One obvious way is to increase the loading of the other flame retardants. However, small molecular halogen free flame retardants, when added at increasingly higher loading, will continue the trend to negatively impact other properties of the flame-retardant composition including mechanical properties such as impact strength and thermal properties such as heat deflection temperature (HDT). But polymeric flame retardants such as polyphosphonate have more room to play due to the high molecular weight. In other words, the loading of the polymeric flame retardants also needs to be increased to maintain the same flame retardancy when the PTFE is removed, but the flame-retardant composition based on polymeric flame retardant will have less reduction in mechanical and thermal properties. And with the help of impact modifiers, it is possible that impact strength can be restored. In other words, without PTFE, the iterative process of balancing mechanical properties and flame retardancy with impact modifiers and flame retardants can still be pursued to find compositions meeting all performance requirements.

It is known that certain impact modifiers can provide the expected improvement in impact properties with less negative effect on flame retardancy. It is found that a silicone-acrylic-based rubber impact modifier not only provides expected increase in impact property, but together with polyphosphonate also improves the flame retardancy significantly for polycarbonate.

Further unexpectedly, other impact modifiers commonly known for their negative impact on flame retardancy are also showing positive effect on FR in PTFE free flame-retardant formulations based on polyphosphonates. For example, Lotader AX8900, an ethylene-methyl acrylate-glycidyl methacrylate terpolymer, is a well-known additive to improve impact strength of PBT, PET, PC/PBT, PC/PET and PC/ABS alloys. In previous work by FRX, its negative impact on FR for FR PC/PET was well documented in Table 5 below. But unexpectedly in the recent PTFE free work, it has been found to bring positive effect on both FR and impact properties in PC/PBT and PC/PET blend.

For example, one impact modifier disclosed herein is a silicone-acrylic-based rubber impact modifier for flame retardant polycarbonate (PC) resins. Improvement in impact property using this impact modifier has been illustrated when the impact modifier is present in amounts of 3%, 4%, and 5%, but there is no mention of flame retardancy. In US Patent Application Publication No. 2016/0137836, examples of incorporating silicone-acrylic-based impact modifiers in flame retardant PC formulations were shown and one of them achieved V-0 at 1.6 mm, but all examples contained PTFE and the impact modifiers were at levels of 3% or above (e.g., 5%). Of the various impact modifier candidates, it has been found that a siloxane grafted impact modifier may be preferred. Such flame retardant materials may include a core of siloxane and a shell of acrylic esters. Without wishing to be bound by theory, a core/shell siloxane/(meth)acrylate copolymer impact modifier may be especially suitable for providing both impact toughness and additional flame retardance to the compound.

The present disclosure provides compositions which not only achieve an increase in impact property, but also improves the flame retardancy when combined with polyphosphonate. Too much impact modifier can, without wishing to be bound by theory, cause negative impact on flame retardancy, while too low impact modifier loading does not result in a notable improvement in flame retardancy. In addition, if polyphosphonate is not at a sufficiently high loading, the impact modifier does not show appreciable positive effect on flame retardancy. While more experiments are underway, the available data show that for flame retardant polycarbonate compositions at levels of impact modifier below 3%, the impact modifier used together with polyphosphonate is able to improve both impact property and flame retardancy at the same time, and UL-94 V-0 at 1.6 mm was able to be achieved without the use of PTFE.

It is well known that silicone-based materials are potential flame retardants as they produce protective surface coatings during a fire. Different from common commercially available silicone-based flame retardants, the impact modifier of the present disclosure has acrylate polymer as its shell, which is even more flammable than the resin matrix polycarbonate. When the negative impact on flame retardancy from the acrylate component is more than the positive impact from the silicone component, the overall impact on flame retardancy by the impact modifier will be negative. This explains that not all silicone-acrylate-based impact modifier would have a similar effect as the compositions of the present disclosure, and the composition of a flame retardant material must be carefully balanced to improve flame retardancy.

In some embodiments, there is provided a flame-retardant composition which includes polycarbonate or a polycarbonate blend, a phosphorous-containing flame retardant, and an impact modifier, wherein the flame-retardant composition exhibits enhanced impact properties and flame retardancy compared to the impact properties and flame retardancy of the composition without the impact modifier.

In some embodiments, the composition is free of polytetrafluoroethylene (PTFE). In the context of the present specification, being free of PTFE does not necessarily exclude the inclusion of trace amount of PTFE. For example, the composition may contain PTFE in an amount up to less than 2000 ppm by mass, preferably 50 ppm by mass, more preferably 10 ppm by mass. The PTFE content is most preferably substantially zero, i.e., below detection limit.

The composition may include pigments, stabilizers, fillers, processing aids, other additives, additional flame retardant compounds, or combinations thereof.

In some embodiments, the phosphorus-containing flame retardant includes polyphosphonate, poly(phosphonate-co-carbonate), or combinations thereof.

Without wishing to be bound by theory, the impact modifier may be selected based on the resin matrix of the composition. For example, a composition which contains polycarbonate may include a different impact modifier than a composition which includes a polycarbonate blend.

In some embodiments, the composition includes polycarbonate, and the impact modifier is of core-shell type and has silicone content is 10% by mass or more.

Hereinafter, embodiments of the present invention will be described in detail. However, the present invention is not limited to the explanation of the embodiments, and those other than the following examples can be appropriately modified and implemented as long as the gist of the present invention is not impaired. In the present invention, the vinyl monomer means a compound having a polymerizable double bond. In the present invention, (meth)acrylic means one or both of acrylic and methacrylic, and the (meth)acrylic acid ester means one or both of an acrylic acid ester and a methacrylic acid ester. In the present specification, “to” is used in a meaning that includes numerical values described before and after the “to” as a lower limit value and an upper limit value. That is, a numerical value represented by “A to B” means A or more and B or less.

### <Phosphorous-Containing Flame Retardant>

The phosphorous-containing flame retardant is preferably polyphosphonate, poly(phosphonate-co-carbonate), or combinations thereof. Specifically, it is preferable comprises tetrakis(2,6-dimethylphenyl) 1,3-phenylene bisphosphate, bisphenol A bis (diphenyl phosphate) (BPADP), resorcinol bis(diphenyl phosphate) (RDP), aromatic bisphosphate, or combinations thereof.

### <Polyorganosiloxane-Containing Polymer>

The polyorganosiloxane-containing polymer (hereinafter, also denoted as a “polymer (C)”) according to one aspect of the present invention consists of a polymer (A) and a second vinyl polymer (B) (hereinafter, also denoted as a “vinyl polymer (B)”). The polymer (A) is preferably a composite body that contains at least a polyorganosiloxane (A1) and further containing a first vinyl polymer (A2) (hereinafter, also denoted as a “vinyl polymer (A2)”). It is preferable that the polyorganosiloxane (A1) and the vinyl polymer (B) are at least partially crosslinked. The polyorganosiloxane-containing polymer is preferably a graft copolymer that has a composite body (a composite rubber-like polymer) of the polyorganosiloxane (A1) and the vinyl polymer (A2) and has a graft part containing a vinyl polymer (B1).

The polyorganosiloxane-containing polymer is the impact modifier is of core-shell type and from improving impact strength and flame retardancy, has silicone content is 10% by mass or more, more preferably 29% by mass or more, still more preferably 40% by mass or more, still more preferably 50% by mass or more, and particularly preferably 80% by mass or more. From the viewpoint of improving appearance of molded pieces, the silicone content of the polyorganosiloxane-containing polymer is preferably 99% by mass or less, more preferably 97% by mass or less, still more preferably 95% by mass or less.

For improving impact strength, the mass average particle diameter Dw of the polyorganosiloxane-containing polymer is 100 nm or more, preferably 150 nm or more, and more preferably 200 nm or more, and particularly preferably 250 nm or more. From the viewpoint of improving productivity, the mass average particle diameter Dw of the polyorganosiloxane-containing polymer is preferably 1,000 nm or less, more preferably 800 nm or less, still more preferably 600 nm or less, and particularly preferably 500 nm or less. In this context, the mass average diameter Dw is an arithmetic mean diameter.

### (Polyorganosiloxane (A1))

The polyorganosiloxane (A1) is a polymer containing an organosiloxane unit. The term “organosiloxane unit” means an Si—O unit to which an organic group is bonded. The polyorganosiloxane has a structure represented by Formula (1).

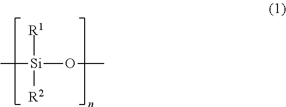

In Formula (1), R¹ and R² each independently represent a hydrogen atom, a halogen atom, or a monovalent organic group, and at least one of R¹ and R² is a monovalent organic group. n represents an integer of 2 or more.

The polyorganosiloxane (A1) can be obtained by polymerizing an organosiloxane mixture containing an organosiloxane. The organosiloxane mixture may further contain a component to be used as necessary. Examples of the component to be used as necessary include a siloxane-based crosslinking agent, a siloxane-based crossing agent, and a siloxane oligomer having a terminal-blocking group.

Examples of the organosiloxane include a chain-like organosiloxane, an alkoxysilane compound, and a cyclic organosiloxane. An alkoxysilane compound or a cyclic organosiloxane is preferable, and a cyclic organosiloxane is more preferable due to the reason that the polymerization stability is high and the polymerization rate is high.

The alkoxysilane compound is preferably a difunctional alkoxysilane compound. Examples thereof include dimethyldimethoxysilane, dimethyldiethoxysilane, diethoxydiethylsilane, dipropoxydimethylsilane, diphenyldimethoxysilane, diphenyldiethoxysilane, methylphenyldimethoxysilane, and methylphenyldiethoxysilane. One kind of alkoxysilane compound can be used alone or in a combination of two or more kinds thereof.

The cyclic organosiloxane is preferably a 3- to 7-membered cyclic organosiloxane, where only Si atoms are counted as ring-forming atoms. Examples thereof include hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, and octaphenylcyclotetrasiloxane. One kind of cyclic organosiloxane can be used alone or in a combination of two or more kinds thereof. Octamethylcyclotetrasiloxane is preferable due to the reason that it is easy to control the particle diameter distribution. From the viewpoint of obtaining the polymer (C) capable of further increasing the impact strength of the molded product, the organosiloxane is preferably at least one selected from the group consisting of a cyclic dimethylsiloxane and a difunctional dialkylsilane compound.

The term “cyclic dimethylsiloxane” is a cyclic siloxane having two methyl groups on the silicon atom. Examples thereof include hexamethylcyclotrisiloxane, octamethylcyclotetrasiloxane, decamethylcyclopentasiloxane, and dodecamethylcyclohexasiloxane. One kind of cyclic dimethylsiloxane can be used alone or in a combination of two or more kinds thereof.

The term “difunctional dialkylsilane compound” is a silane compound having two alkoxy groups and two alkyl groups on the silicon atom. Examples thereof include dimethyldimethoxysilane, dimethyldiethoxysilane, diethoxydiethylsilane, and dipropoxydimethylsilane. One kind of difunctional dialkylsilane compound can be used alone or in a combination of two or more kinds thereof.

The siloxane-based crosslinking agent is preferably a siloxane-based crosslinking agent having a siloxy group. Examples of the siloxane-based crosslinking agent include trifunctional or tetrafunctional silane-based crosslinking agent such as trimethoxymethylsilane, triethoxyphenylsilane, tetramethoxysilane, tetraethoxysilane, tetra-n-propoxysilane, and tetrabutoxysilane. A tetrafunctional crosslinking agent is preferable, and tetraethoxysilane is more preferable.

The siloxane-based crossing agent has a siloxy group (—Si—O—) and a functional group polymerizable with a vinyl monomer. Examples of the siloxane-based crossing agent include a siloxane represented by Formula (I).

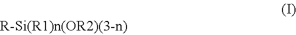

In Formula (I), R1 represents a methyl group, an ethyl group, a propyl group, or a phenyl group. R2 represents an organic group such as a hydrocarbon group, and it is, for example, preferably a methyl group, an ethyl group, a propyl group, or a phenyl group. n represents 0, 1, or 2. R represents a functional group represented by any one of Formulae (I-1) to (I-4).

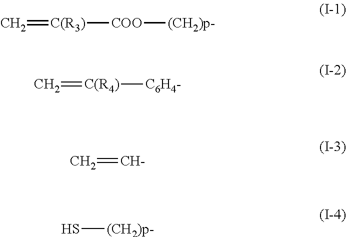

In these formulas, R₃ and R₄ each independently represent a hydrogen atom or a methyl group, and p represents an integer of 1 to 6.

Examples of the functional group represented by Formula (I-1) include a methacryloyloxyalkyl group. Specific examples of the siloxane represented by Formula (I-1) include β-methacryloyloxyethyldimethoxymethylsilane, γ-methacryloyloxypropylmethoxydimethylsilane, γ-methacryloyloxypropyldimethoxymethylsilane, γ-methacryloyloxypropyltrimethoxysilane, γ-methacryloyloxypropylethoxydiethylsilane, γ-methacryloyloxypropyldiethoxymethylsilane, and 6-methacryloyloxybutyldiethoxymethylsilane. Examples of the functional group represented by Formula (I-2) include a vinylphenyl group. Examples of the siloxane having a group represented by Formula (I-2) include vinylphenylethyldimethoxysilane. Examples of the siloxane having a functional group represented by Formula (I-3) include vinyltrimethoxysilane and vinyltriethoxysilane. Examples of the functional group represented by Formula (I-4) include a mercaptoalkyl group. Examples of the siloxane having a group represented by Formula (I-4) include γ-mercaptopropyldimethoxymethylsilane, γ-mercaptopropylmethoxydimethylsilane, γ-mercaptopropyldiethoxymethylsilane, γ-mercaptopropylethoxydimethylsilane, and γ-mercaptopropyltrimethoxysilane.

One kind of siloxane-based crossing agent can be used alone or in a combination of two or more kinds thereof. The siloxane-based crossing agent is preferably γ-methacryloyloxypropylmethyldimethoxysilane due to the reason that a sea-island structure is likely to be formed in a case where the polyorganosiloxane (A1) and the vinyl polymer (A2) are formed into a composite body.

When the organosiloxane mixture contains a siloxane-based crossing agent, the proportion of the siloxane-based crossing agent in 100% by mass of the organosiloxane mixture is preferably 0.05% by mass or more, more preferably 0.1% by mass or more, and still more preferably 0.5% by mass or more. The proportion of the siloxane-based crossing agent in 100% by mass of the organosiloxane mixture is preferably 20% by mass or less, more preferably 10% by mass or less, and still more preferably 5% by mass or less. The upper and lower limits thereof may be combined in any combination. For example, 0.05% to 20% by mass is preferable, 0.1% to 10% by mass is more preferable, and 0.5% to 5% by mass is still more preferable. In a case where the proportion of the siloxane-based graft crossing agent is within the ranges of the above-described upper limit value and the above-described lower limit value, it is possible to sufficiently form a covalent bond between the polyorganosiloxane (A1) and the vinyl polymer (A2), and it is possible to obtain the polymer (C) having a favorable impact strength.

The mass average particle diameter of the polyorganosiloxane (A1) is preferably 100 nm or more, more preferably 200 nm or more, and still more preferably 300 nm or more. The mass average particle diameter of the polyorganosiloxane (A1) is preferably 1,000 nm or less, more preferably 800 nm or less, and still more preferably 600 nm or less. The upper and lower limits thereof may be combined in any combination. For example, 100 to 1,000 nm is preferable, 200 to 800 nm is more preferable, and 300 to 600 nm is still more preferable. In a case where the mass average particle diameter of the polyorganosiloxane (A1) is within the ranges of the above-described upper limit value and the above-described lower limit value, the mass average particle diameter of the polymer (C) is easily adjusted within the ranges of the preferred upper limit value and lower limit value described above.

### <Production Method for Polyorganosiloxane (A1)>

The production method for the polyorganosiloxane (A1) is not particularly limited, and it is possible to employ, for example, a production method (M) in which an organosiloxane mixture, which contains an organosiloxane, a siloxane-based crosslinking agent as necessary, a siloxane-based crossing agent as necessary, and a siloxane oligomer having a terminal-blocking group, as necessary, is emulsified with an emulsifying agent and water to prepare an emulsion, the organosiloxane mixture is polymerized in this emulsion at a high temperature in the presence of an acid catalyst, and then the acid catalyst is neutralized with an alkaline substance to obtain a latex of the polyorganosiloxane. In the following description, the description will be made regarding a case where the “organosiloxane mixture” is used as a raw material for polymerization. The same production process can be applied to a case where the “organosiloxane” is used as a raw material for polymerization.

In the production method (M), examples of the preparation method for an emulsion include a method of forming fine particles with a shearing force due to high-speed rotation, for example, by using a homogenization mixer; and a method of forming fine particles with a jet force due to a high-pressure generator, for example, by carrying out mixing by high speed stirring using a homogenizer. A method using a homogenizer is preferable since it is easy to narrow the distribution of the particle diameter of the latex of the polyorganosiloxane.

Examples of the mixing method for an acid catalyst in the polymerization include a method in which an acid catalyst together with an organosiloxane mixture, an emulsifying agent, and water is collectively added and mixed (a method 1); a method in which an aqueous acid catalyst solution is collectively added to an emulsion of an organosiloxane mixture (a method 2); and a method in which an emulsion of an organosiloxane mixture is dropwise added and mixed in a high-temperature aqueous acid catalyst solution at a constant rate (a method 3). The method 3 is preferable due to the reason that the particle diameter of the polyorganosiloxane is easily controlled.

Examples of the mixing method for an acid catalyst in the polymerization include a method in which an acid catalyst together with an organosiloxane mixture, an emulsifying agent, and water is collectively added and mixed (a method 1); a method in which an aqueous acid catalyst solution is collectively added to an emulsion of an organosiloxane mixture (a method 2); and a method in which an emulsion of an organosiloxane mixture is dropwise added and mixed in a high-temperature aqueous acid catalyst solution at a constant rate (a method 3). The method 3 is preferable due to the reason that the particle diameter of the polyorganosiloxane is easily controlled.

The crosslinking reaction between silanols proceeds at a temperature of 30° C. or lower. Therefore, after polymerization at a high temperature of 50° C. or higher, it is also possible to maintain the generated latex at a temperature of 30° C. or lower for 5 hours to 100 hours in order to increase the crosslinking density of the polyorganosiloxane.

The polymerization reaction of the organosiloxane mixture can be completed by neutralizing the reaction system containing the latex to a pH of 6 or more and 8 or less with an alkaline substance such as sodium hydroxide, potassium hydroxide, or an aqueous ammonia solution.

The emulsifying agent is not particularly limited as long as the organosiloxane mixture can be emulsified, and it is preferably an anionic emulsifying agent or a nonionic emulsifying agent. Examples of the anionic emulsifying agent include sodium alkylbenzenesulfonate, sodium alkyldiphenyl ether disulfonate, sodium alkyl sulfate, sodium polyoxyethylene alkyl sulfate, and sodium polyoxyethylene nonylphenyl ether sulfate. Examples of the nonionic emulsifying agent include a polyoxyethylene alkyl ether, a polyoxyethylene alkylene alkyl ether, a polyoxyethylene distyrene phenyl ether, a polyoxyethylene tribenzylphenyl ether, and a polyoxyethylene polyoxypropylene glycol. One kind of emulsifying agent can be used alone or in a combination of two or more kinds thereof.

The using amount of the emulsifying agent is preferably 0.05 parts by mass or more, and more preferably 0.1 parts by mass or more with respect to 100 parts by mass of the organosiloxane mixture. The using amount of the emulsifying agent is preferably 20 parts by mass or less and more preferably 10 parts by mass or less with respect to 100 parts by mass of the organosiloxane mixture. The upper and lower limits thereof may be combined in any combination. For example, 0.05 to 20 parts by mass is preferable, and 0.1 to 10 parts by mass is more preferable. The particle diameter of the latex of the polyorganosiloxane can be adjusted to a desired value according to the using amount of the emulsifying agent. The particle diameter can be reduced by increasing the amount of the emulsifying agent, or the particle diameter can be increased by decreasing the amount of the emulsifying agent. In a case where the using amount of the emulsifying agent is equal to or larger than the above-described lower limit value, it is possible to increase the emulsification stability of the emulsion of the organosiloxane mixture. In a case where the using amount of the emulsifying agent is equal to or smaller than the above-described upper limit value, the heat-discoloration resistance and the external appearance of the surface of the molded product are excellent.

Examples of the acid catalyst that is used in the polymerization of the organosiloxane mixture include sulfonic acids such as an aliphatic sulfonic acid, an aliphatic-substituted benzenesulfonic acid, and an aliphatic-substituted naphthalenesulfonic acid; and mineral acids such as sulfuric acid, hydrochloric acid, and nitric acid. One kind of acid catalyst can be used alone or in a combination of two or more kinds thereof. In a case where mineral acids are used, it is easy to narrow the distribution of the particle diameter of the latex of the polyorganosiloxane, and further, it is easy to suppress the occurrence of defects (the decrease in the resistance to thermal decomposability of the molded product, poor external appearance, and the like) due to the emulsifying agent component in the polyorganosiloxane latex.

The using amount of the acid catalyst is preferably 0.005 parts by mass or more and 40 parts by mass or less with respect to 100 parts by mass of the organosiloxane. In a case where the using amount of the acid catalyst is 0.005 parts by mass or more, the organosiloxane mixture can be polymerized in a short time. In a case where the using amount of the acid catalyst is 40 parts by mass or less, the heat-discoloration resistance and the external appearance of the surface of the molded product are excellent.

The using amount of the acid catalyst is a factor that determines the particle diameter of the polyorganosiloxane (A1). Therefore, in order to obtain the polyorganosiloxane (A1) having a particle diameter described below, the using amount of the acid catalyst is preferably set to 1 part by mass or more and 30 parts by mass or less with respect to 100 parts by mass of the organosiloxane. It is noted that in a case where the using amount of the acid catalyst is small, the particle diameter tends to be large.

As necessary, an emulsifying agent may be added to the latex of the polyorganosiloxane obtained by the production method (M) for the intended purpose of improving mechanical stability. The emulsifying agent is preferably the same anionic emulsifying agents and nonionic emulsifying agents as those exemplified above.

### (First Vinyl Polymer (A2))

The polymer (A) may contain the vinyl polymer (A2). When the polymer (A) contains the vinyl polymer (A2), the polymer (A) may be a polymer in which the vinyl polymer (A2) and the polyorganosiloxane (A1) are crosslinked or may be a composite polymer in which the polyorganosiloxane (A1) and the vinyl polymer (A2) are not crosslinked, where it is preferable that the vinyl polymer (A2) and the polyorganosiloxane (A1) are crosslinked.

The vinyl polymer (A2) is a polymer obtained by polymerizing a vinyl monomer component (a2). That is, the vinyl polymer (A2) contains a vinyl monomer unit derived from the vinyl monomer component (a2). The vinyl monomer component (a2) constituting the first vinyl polymer (A2) may be one kind of vinyl monomer or may be two or more kinds of vinyl monomers.

From the viewpoint of the impact strength of the molded product, the vinyl monomer component (a2) preferably contains a (meth)acrylate monomer (hereinafter, also denoted as a “monomer (a2-1)”).

The monomer (a2-1) is not particularly limited, and preferred examples thereof include a (meth)acrylate in which the alkyl group has 1 or more and 20 or less carbon atoms. Examples thereof include alkyl acrylates such as methyl acrylate, ethyl acrylate, n-propyl acrylate, n-butyl acrylate, 2-ethylhexyl acrylate, and n-octyl acrylate; and alkyl methacrylates such as methyl methacrylate, ethyl methacrylate, n-propyl methacrylate, n-butyl methacrylate, i-butyl methacrylate, t-butyl methacrylate, hexyl methacrylate, 2-ethylhexyl methacrylate, lauryl methacrylate, tridecyl methacrylate, and stearyl methacrylate.

The (meth)acrylate is preferably an alkyl acrylate having 1 or more and 20 or less carbon atoms. Due to the reason that the impact strength of the molded product is more favorable, the alkyl group of the alkyl acrylate preferably has 2 or more carbon atoms, more preferably has 3 or more carbon atoms, and still more preferably 4 or more carbon atoms, and it more preferably has 16 or less carbon atoms, more preferably 12 or less carbon atoms, and still more preferably 8 or less carbon atoms. n-butyl acrylate is particularly preferable. One kind of monomer (a2-1) can be used alone or in a combination of two or more kinds thereof.

When the vinyl monomer component (a2) contains the monomer (a2-1), it may contain another monomer. Examples of the other monomer include a polyfunctional monomer (hereinafter, also denoted as a “monomer (a2-2)”) capable of being copolymerized with the monomer (a2-1). From the viewpoint of the impact strength of the molded product, the vinyl monomer component (a2) preferably contains the monomer (a2-1) and the monomer (a2-2).

The monomer (a2-2) is not particularly limited, and examples thereof include (meth)acrylate and cyanurate. Examples of the (meth)acrylate include ethylene glycol dimethacrylate, propylene glycol dimethacrylate, ethylene glycol diacrylate, propylene glycol diacrylate, and allyl methacrylate. Examples of the cyanurate include triallyl cyanurate and triallyl isocyanurate.

Due to the reason that the impact strength of the molded product is more favorable, allyl methacrylate, triallyl cyanurate, or triallyl isocyanurate is preferable, and allyl methacrylate is more preferable. One kind of monomer (a2-2) can be used alone or in a combination of two or more kinds thereof.

The proportion of the monomer (a2-1) in 100% by mass of the vinyl monomer component (a2) is not particularly limited, and it is preferably 60% by mass or more, more preferably 70% by mass or more, still more preferably 80% by mass or more, and particularly preferably 90% by mass or more, from the viewpoint of improving the impact strength of the molded product. The proportion of the monomer (a2-1) in 100% by mass of the vinyl monomer component (a2) is 100% by mass or less and is preferably 99.9% by mass or less. The upper and lower limits thereof may be combined in any combination. For example, 60% to 100% by mass is preferable, 70% to 100% by mass is more preferable, 80% to 99.9% by mass is still more preferable, and 90% to 99.9% by mass is particularly preferable.

The proportion of the monomer (a2-2) in 100% by mass of the vinyl monomer component (a2) is not particularly limited, and it is preferably 0.1% by mass or more and more preferably 2% by mass or less in order to improve the impact strength.

The vinyl monomer component (a2) may contain another monomer (a2-3) other than the monomer (a2-1) and the monomer (a2-2). The other monomer (a2-3) is not particularly limited, and examples thereof include an aromatic vinyl monomer, a vinyl cyanide monomer, and a (meth)acrylic group-modified silicone.

The aromatic vinyl monomer is not particularly limited, and examples thereof include styrene and α-methylstyrene. The vinyl cyanide monomer is not particularly limited, and examples thereof include acrylonitrile and methacrylonitrile. One kind of other monomer (a2-3) can be used alone or in a combination of two or more kinds thereof.

### (Polymer (A))

The polymer (A) includes the polyorganosiloxane (A1) and the vinyl polymer (A2). It is preferable that the polymer (A) has a function as a composite rubber of the polyorganosiloxane (A1) and the vinyl polymer (A2). For the function as the composite rubber, the glass transition temperature (hereinafter, may be referred to as Tg) of each of the polyorganosiloxane (A1) and the vinyl polymer (A2) is preferably 0° C. or lower.

The mass ratio represented by “polyorganosiloxane (A1)/vinyl polymer (A2)” in the polymer (A) is preferably 12/88 or more and more preferably 30/70 or more, and it is preferably 99/1 or less and more preferably 95/5 or less, from the viewpoint of the impact strength and the flame retardance of the molded product. The upper and lower limits thereof may be combined in any combination.

### (Production Method for Polymer (A))

The production method for the polymer (A) is not particularly limited, and it is preferably a method of polymerizing the vinyl monomer component (a2) that constitutes the vinyl polymer (A2), in the presence of the latex containing the polyorganosiloxane (A1) due to the reason that the impact strength of the molded product is excellent.

The method of polymerizing the vinyl monomer component (a2) in the presence of the latex containing the polyorganosiloxane (A1) is not particularly limited. Examples thereof include a method in which the vinyl monomer component (a2) is dropwise added to the latex containing the polyorganosiloxane (A1) (a method (i); a method in which a part of the vinyl monomer component (a2) is added to the latex containing the polyorganosiloxane (A1) under conditions in which polymerization is not started, the particles of the polyorganosiloxane (A1) is impregnated with the resultant mixture, and then the polymerization is started, and the remainder of the vinyl monomer component (a2) is subsequently added dropwise or collectively to carry out polymerization (a method ii); and a method in which the entire amount of the vinyl monomer component (a2) is added to the latex containing the polyorganosiloxane (A1) under conditions in which polymerization is not started, the particles of the polyorganosiloxane (A1) is impregnated with the resultant mixture, and then polymerization is carried out (a method iii). The method iii is preferable due to the reason that the impact strength of the molded product is excellent.

The production method for the vinyl polymer (A2) is not particularly limited, and examples thereof include a method of polymerizing the vinyl monomer (a2) by an emulsion polymerization method, a suspension polymerization method, or a fine suspension polymerization method, where an emulsion polymerization method is preferable.

As the radical polymerization initiator that is used in the polymerization of the vinyl monomer (a2), the following initiators are used: an azo-based initiator; a peroxide; and a redox-based initiator obtained by combining a peroxide and a reducing agent. One kind of radical polymerization initiator can be used alone or in a combination of two or more kinds thereof. An azo-based initiator or a redox-based initiator is preferable.

Examples of the azo-based initiator include oil-soluble azo-based initiators such as 2,2′-azobisisobutyronitrile, dimethyl 2,2-azobis(2-methylpropionate), 2,2′-azobis(2,4-dimethylvaleronitrile), and 2,2′-azobis(2-butyronitrile); and water-soluble azo-based initiators such as 4,4′-azobis(4-cyanovaleric acid), 2,2′-azobis[N-(2-carboxymethyl)-2-methylpropionamidine]hydrate, 2,2′-azobis-(N, N′-dimethyleneisobutylamidine) dihydrochloride, and 2,2′-azobis[2-(2-imidazolin-2-yl)propane]dihydrochloride. One kind of these can be used alone or in a combination of two or more kinds thereof.

Examples of the peroxide include inorganic peroxides such as hydrogen peroxide, potassium persulfate; and ammonium persulfate, and organic peroxides such as diisopropylbenzene hydroperoxide, p-menthane hydroperoxide, cumene hydroperoxide, t-butyl hydroperoxide, succinic acid peroxide, t-butylperoxyneodecanoate, t-butylperoxyneoheptanoate, t-butylperoxypivalate, 1,1,3,3-tetramethylbutylperoxy-2-ethylhexanoate, and t-butylperoxy-2-ethylhexanoate. One kind of peroxide can be used alone or in a combination of two or more kinds thereof.

When combining a peroxide with a reducing agent to obtain a redox-based initiator, it is preferable to use, in combination, the above-described peroxide, a reducing agent such as sodium formaldehyde sulfoxylate, L-ascorbic acid, fructose, dextrose, sorbose, or inositol, and ferrous sulfate/disodium ethylenediaminetetraacetic acid. One kind of redox-based initiator can be used alone or in a combination of two or more kinds thereof.

Since it is easy to obtain a graft copolymer having excellent impact resistance, the radical polymerization initiator that is used in the polymerization of the vinyl monomer (a2) is preferably a radical polymerization initiator of which the solubility in water at 20° C. is 5% by mass or less, and more preferably a radical polymerization initiator of which the solubility in water at 20° C. is 2% by mass or less.

Examples of the radical polymerization initiator of which the solubility in water at 20° C. is 5% by mass or less include cumene hydroperoxide, diisopropylbenzene hydroperoxide, p-menthane hydroperoxide, t-butylperoxyneodecanoate, t-butylperoxyneoheptanoate, t-butylperoxypivalate, 1,1,3,3-tetramethylbutylperoxy-2-ethylhexanoate, t-butylperoxy-2-ethylhexanoate, 2,2′-azobisisobutyronitrile, dimethyl 2,2′-azobis(2-methylpropionate), 2,2′-azobis(2,4-dimethylvaleronitrile), and 2,2′-azobis(2-butyronitrile) One kind of the radical polymerization initiator of which the solubility in water at 20° C. is 5% by mass or less can be used alone or in a combination of two or more kinds thereof.

The solubility of the radical polymerization initiator in water at 20° C. can be known from catalogs or the like of various radical polymerization initiators.

When an azo-based initiator is used as the radical polymerization initiator, the using amount of the azo-based initiator is preferably 0.01 to 1 part by mass with respect to the total of 100 parts by mass of the monomers. When a redox-based initiator is used as the radical polymerization initiator, the using amount of the peroxide is preferably 0.01 to 1 part by mass with respect to the total of 100 parts by mass of the monomers. When a redox-based initiator is used as the radical polymerization initiator, the using amount of the reducing agent is preferably 0.01 to 1 part by mass with respect to the total of 100 parts by mass of the monomers.

### (Second Vinyl Polymer (B))

The vinyl polymer (B) is a polymer obtained by polymerizing the vinyl monomer component (b) and is a polymer containing a constitutional unit derived from the vinyl monomer. The vinyl monomer component (b) constituting the vinyl polymer (B) may be any vinyl monomer of one or more kinds.

The vinyl monomer constituting the vinyl monomer component (b) is not particularly limited; however, preferred examples thereof include a (meth)acrylate monomer.

The (meth)acrylate monomer is not particularly limited, and examples thereof include an alkyl (meth)acrylate. When one or more kinds of vinyl monomers contain an alkyl (meth)acrylate such as a methyl (meth)acrylate, a graft copolymer to be obtained tends to have excellent compatibility and dispersibility in a thermoplastic resin such as a polycarbonate-based resin. Examples of the alkyl (meth)acrylate include alkyl methacrylates such as methyl methacrylate, ethyl methacrylate, n-butyl methacrylate, and i-butyl methacrylate; and methyl acrylate, ethyl acrylate, and n-butyl acrylate. One kind of (meth)acrylate monomer may be used alone, or two or more kinds thereof may be used in combination. The number of carbon atoms of the alkyl group of the alkyl (meth)acrylate is not particularly limited, and it is preferably 1 or more, more preferably 12 or less, still more preferably 6 or less, and even still more preferably 4 or less. The upper and lower limits thereof may be combined in any combination. For example, 1 to 12 is preferable, 1 to 6 is more preferable, and 1 to 4 is still more preferable. Methyl methacrylate is particularly preferable.

The vinyl monomer component (b) further contains one or more monomers selected from the group consisting of a polyfunctional vinyl monomer, an aromatic vinyl monomer, and a vinyl cyanide monomer.

Examples of the polyfunctional vinyl monomer include allyl (meth)acrylate, triallyl cyanurate, divinylbenzene, diallyl phthalate, and ethylene glycol di(meth)acrylate. One kind of polyfunctional vinyl monomer may be used alone, or two or more kinds thereof may be used in combination.

The aromatic vinyl monomer is not particularly limited, and examples thereof include styrene and α-methylstyrene. One kind of aromatic vinyl monomer may be used alone, or two or more kinds thereof may be used in combination.

The vinyl cyanide monomer is not particularly limited, and examples thereof include acrylonitrile and methacrylonitrile. One kind of vinyl cyanide monomer may be used alone, or two or more kinds thereof may be used in combination.

The proportion of the (meth)acrylate monomer in 100% by mass of the vinyl polymer (B) is preferably 50% by mass or more, more preferably 70% by mass or more, still more preferably 80% by mass or more, and particularly preferably 90% by mass or more.

The Tg of the vinyl polymer (B) is preferably 70° C. or higher, more preferably 80° C. or higher, still more preferably 90° C. or higher, and it is preferably 105° C. or lower. The upper and lower limits thereof may be combined in any combination. 70° C. to 105° C. is preferable, 80° C. to 105° C. is more preferable, and 90° C. to 105° C. is still more preferable. In a case where Tg of the vinyl polymer (B) is equal to or larger than the above-described lower limit value, the fluidity or the like of the powder of the polymer (C) to be obtained is favorable. The Tg of the vinyl polymer (B) can be adjusted depending on the kind and ratio of the vinyl monomer constituting the vinyl monomer component (b).

The Tg of the vinyl polymer (B) can be determined by the FOX expression. In this case, for the Tg of the homopolymer of the vinyl monomer constituting the vinyl monomer component (b), it is possible to use, for example, the value described in “POLYMER HANDBOOK” (Wiley, Interscience Inc./1999) can be used. The Tg of a homopolymer of a vinyl monomer, which is not described in this document, can be calculated using the Bicerano's method “Prediction of Polymer Properties” (MARCEL DEKKER/2002).

### (Production Method for Polymer (C))

The polymer (C) can be produced, for example, by subjecting the vinyl monomer component (b) to polymerization (graft polymerization) in the presence of the polymer (A). As a result, a polymer in which a part or whole of the vinyl polymer (B) is grafted to the polymer (A) is obtained.

The production method for the polymer (C) is not particularly limited and is preferably a method in which the vinyl monomer component (b) is added to a latex of the polymer (A), and the vinyl monomer component (b) is polymerized in the latex. The latex of the polymer (A) is preferably produced by polymerizing the vinyl monomer component (a2) in the presence of the latex containing the polyorganosiloxane (A1).

The conditions for polymerizing the vinyl monomer component (b) are not particularly limited, and conventional conditions can be applied. Examples thereof include conditions of 45° C. to 95° C. and 0.1 to 10 hours.

The method of adding the vinyl monomer component (b) to the latex of the polymer (A) is not particularly limited, and it is preferable to dropwise add the vinyl monomer component (b) due to the reason that the generation of cullet can be suppressed. The entire amount of the vinyl monomer component (b) may be continuously added dropwise, or the vinyl monomer component (b) may be dividedly added dropwise in a plurality of times while setting a holding time during which the vinyl monomer (b) is not added dropwise.

After polymerizing the vinyl monomer component (b), it is preferable to recover the polymer (C) as a powder (or a powder group or a powder group containing impurities) from the latex of the obtained polymer (C). When recovering the polymer (C) as a powder, it is possible to use a direct drying method such as a spray drying method or a solidification method. In the direct drying method, auxiliary agents added during polymerization can be usually allowed to remain in the obtained powder. In the solidification method, in the washing step after coagulation, it is possible to reduce the residues of the polymerization auxiliary agent contained in the obtained powder, such as the emulsifying agent used during polymerization or a coagulation salt thereof, and an initiator. A powder recovery method can be appropriately selected so that a desired residual state is obtained in a case where the polymer (C) is added to the thermoplastic resin.

The spray drying method, which is a direct drying method, is a method in which the latex of the polymer (C) is sprayed into a dryer in the form of fine liquid droplets and dried by being applied with a heating gas for drying. Examples of the method of generating fine liquid droplets include a rotary disk method, a pressurized nozzle method, a two-flow nozzle method, and a pressurized two-flow nozzle method. The capacity of the dryer may be any capacity from a small capacity such as a capacity that is used in a laboratory to a large capacity such as a capacity that is used industrially. The temperature of the heating gas for drying is preferably 200° C. or lower and more preferably 120 to 180° C. Latexes of two or more kinds of graft copolymers that are produced separately can also be subjected to spray drying together. In order to improve powder characteristics such as blocking and bulk specific gravity during spray drying, it is also possible to add an optional component such as silica to the latex of the polymer (C) and then carry out spray drying.

The solidification method is a method of coagulating the latex of the polymer (C) to separate, recover, and dry the polymer (C). The latex of the polymer (C) is added to hot water in which a solidifying agent has been dissolved, salted out, and solidified to separate the polymer (C), and the separated polymer (C) in a wet state is subjected to dehydration or the like to recover the polymer (C) having a reduced moisture content. The recovered polymer (C) is dried using a squeeze dehydrator or a hot air dryer.

Examples of the solidifying agent include inorganic salts such as aluminum chloride, aluminum sulfate, sodium sulfate, magnesium sulfate, sodium nitrate, and calcium acetate; and acids such as sulfuric acid, where calcium acetate is preferable. One kind of solidifying agent can be used alone or in a combination of two or more kinds thereof.

When the solidifying agent is used as an aqueous solution, the concentration of the aqueous solidifying agent solution is preferably 0.1% by mass or more and more preferably 1% by mass or more from the viewpoint of stably solidifying and recovering the polymer (C). The concentration of the aqueous solidifying agent solution is more preferably 20% by mass or less and more preferably 15% by mass or less from the viewpoint of reducing the amount of the solidifying agent remaining in the recovered polymer (C) to prevent the deterioration of the external appearance of the molded product. The upper and lower limits thereof may be combined in any combination. For example, 0.1% to 20% by mass is preferable, and 1% to 15% by mass is more preferable. The amount of the aqueous solidifying agent solution is not particularly limited and is preferably 10 parts by mass or more and 500 parts by mass or less with respect to 100 parts by mass of the latex of the polymer (C).

A method of bringing the latex of the polymer (C) into contact with the aqueous solidifying agent solution is not particularly limited, and examples thereof include the following methods. (1) A method of continuously adding a latex to an aqueous solidifying agent solution while stirring the aqueous solidifying agent solution and then holding the resultant mixture for a certain period of time, (2) A method of bringing an aqueous solidifying agent solution and a latex into contact with each other while being continuously injected into a container equipped with a stirrer at a constant ratio, and continuously extracting a mixture containing a coagulated polymer and water from the container. The temperature at which a latex is brought into contact with an aqueous solidifying agent solution is not particularly limited and is preferably 30° C. or higher and 100° C. or lower. The contact time is not particularly limited.

The coagulated polymer (C) is washed with water about 1 to 100 times by mass the polymer (C) and separated by filtration. The polymer (C) in a wet state, which has been separated by filtration, is dried using a flow dryer, a squeeze dehydrator, or the like. The drying temperature and the drying time may be appropriately determined depending on the polymer (C) to be obtained. The polymer (C) discharged from the squeeze dehydrator or an extruder may be, without being recovered, sent directly to an extruder or molding machine which produces a resin composition and mixed with a thermoplastic resin to obtain a molded product.

The proportion of the polyorganosiloxane (A1) in 100% by mass of the polymer (C) is preferably less than 100% by mass and more preferably 98% by mass or less. The proportion of the polyorganosiloxane (A1) in 100% by mass of the polymer (C) is preferably 10% by mass or more, more preferably 20% by mass or more, still more preferably 25% by mass or more, and particularly preferably 50% by mass or more. The upper and lower limits thereof may be combined in any combination. For example, 10% by mass or more and less than 100% by mass is preferable, 20% by mass or more and less than 100% by mass is more preferable, 25% to 98% by mass is still more preferable. In a case where the proportion of the polyorganosiloxane (A1) is equal to or larger than the above-described lower limit value, the impact strength of the molded product is excellent. In a case where it is equal to or smaller than the above-described upper limit value, the colored external appearance of the molded product is excellent.

The proportion of the polymer (A) in 100% by mass of the polymer (C) is preferably 60% by mass or more and more preferably 70% by mass or more. The proportion of the polymer (A) in 100% by mass of the polymer (C) is preferably 95% by mass or less and more preferably 90% by mass or less. The upper and lower limits thereof may be combined in any combination. For example, 60% to 95% by mass is preferable, and 70% to 90% by mass is more preferable. In a case where the content of the polymer (A) is equal to or larger than the above-described lower limit value, the impact strength and flame retardance of the molded product are excellent. In a case where it is equal to or smaller than the above-described upper limit value, the dispersibility of the polymer (C) in the thermoplastic resin is excellent, and the external appearance of the molded product to be obtained is excellent.

The proportion of the graft part in 100% by mass of the polymer (C) is preferably 5% by mass or more, more preferably 7.5% by mass or more, and still more preferably 10% by mass or more. The proportion of the graft part in 100% by mass of the polymer (C) is preferably 20% by mass or less, more preferably 17.5% by mass or less, and still more preferably 15% by mass or less. The upper and lower limits thereof may be combined in any combination. For example, 5% to 20% by mass is preferable, 7.5% to 17.5% by mass is more preferable, and 10% to 15% by mass is still more preferable. In a case where the content of the graft part is equal to or larger than the above-described lower limit value, the dispersibility of the polymer (C) in the thermoplastic resin is excellent, and the external appearance of the molded product to be obtained is excellent. In a case where it is equal to or smaller than the above-described upper limit value, the impact strength of the molded product is excellent.

The proportion of the vinyl polymer (B) in 100% by mass of the polymer (C) is preferably 5% by mass or more and more preferably 10% by mass or more. The proportion of the vinyl polymer (B) in 100% by mass of the polymer (C) is preferably 40% by mass or less and more preferably 35% by mass or less. The upper and lower limits thereof may be combined in any combination. For example, 5% to 40% by mass is preferable, and 10% to 35% by mass is more preferable. In a case where the content of the vinyl polymer (B) is equal to or larger than the above-described lower limit value, the dispersibility of the polymer (C) in the thermoplastic resin is excellent, and the external appearance of the molded product to be obtained is excellent. In a case where it is equal to or smaller than the above-described upper limit value, the impact strength of the molded product is excellent.

### <Resin Composition>

A resin composition according to one aspect of the present invention (hereinafter also referred to as “the present resin composition”) contains polycarbonate or a polycarbonate blend, a phosphorous-containing flame retardant, and an impact modifier (a polymer (C)).

In addition to the above, the present resin composition can contain various well-known additives as long as the object of the present invention is not impaired. Examples of the additive include a pigments, stabilizers, fillers, processing aids, other additives, additional flame retardant compounds, or combinations thereof.

The pigments are preferably an inorganic pigment, examples thereof include iron oxide, ultramarine blue, titanium oxide, and carbon black. In a case of being an organic pigment, examples thereof include a phthalocyanine-based or anthraquinone-based blue pigment, a perylene-based or quinacridone-based red pigment, and an isoindolinone-based yellow pigment. Examples of the special pigment include a fluorescent pigment, a metal powder pigment, and a pearl pigment. In a case of being a dye, examples thereof include a nigrosine-based dye, a perinone-based dye, and an anthraquinone-based dye. Various grades of the coloring agent and the pigment, which are in response to required colors, are commercially available, and they can be used. One kind thereof can be used alone or in a combination of two or more kinds thereof.

The stabilizers are for example, a phenol-based stabilizer, a phosphorus-based stabilizer, an ultraviolet absorbing agent, or an amine-based photostabilizer. The fillers are for example, titanium oxide, talc, mica, kaolin, calcium carbonate, or glass flake. Other processing aids and additives include plasticizers, reinforcing agents (for example, a glass fiber, or a carbon fiber) rip preventing agent (for example, fluorinated polyolefin, silicone, or an aramid fiber), a lubricant (for example, a long-chain fatty acid metal salt such as magnesium stearate), a mold release agent (for example, pentaerythritol tetrastearate), a nucleating agent, and an antistatic agent.

The additional flame retardant includes silicone-based, or organic metal salt-based flame retardant.

The proportion of the phosphorous-containing flame retardant in 100% by mass of the present resin composition is not particularly limited and the appropriate proportion may greatly vary depending on various factors such as the targeted flame retardancy, the types of polycarbonate blend, phosphorous-containing flame retardant, etc. For example, generally, the proportion of the phosphorous-containing flame retardant may be 5% by mass or more, 10% by mass or more, 15% by mass or more, 20% by mass or more, 25% by mass or more, or 30% by mass or more. As for the upper limit of the proportion of the phosphorous-containing flame retardant in 100% by mass of the present resin composition, for example, the proportion may be 60.0% by mass or less, more preferably 55.0% by mass or less, 50.0% by mass or less, or 45.0% by mass or less The upper and lower limits thereof may be combined in any combination. For example, the range of the above proportion may be 5% by mass to 50% by mass, 10% by mass to 45% by mass, 15% by mass to 45% by mass, 20% by mass to 45% by mass, 25% by mass to 45% by mass, or 30% by mass to 45% by mass. The proportion of the phosphorous-containing flame retardant as mentioned above tends to result in particularly excellent balance of mechanical properties and flame retardancy.

The phosphorus atom content (P content) in 100% by mass of the present resin composition is preferably 0.1% by mass or more, more preferably 0.5% by mass or more, and still more preferably 1.0% by mass or more. The phosphorus atom content (P content) in 100% by mass of the present resin composition is preferably 5.0% by mass or less, more preferably 4.0% by mass or less, and still more preferably 3.0% by mass or less. The upper and lower limits thereof may be combined in any combination. For example, 0.1% to 5.0% by mass is preferable, 0.5% to 4.0% by mass is more preferable. In a case where the phosphorus atom content (P content) is equal to or larger than the above-described lower limit value, flame retardancy to be obtained is excellent

The proportion of the polymer (C) in 100% by mass of the present resin composition is not particularly limited and is preferably 0.1% by mass or more, more preferably 0.5% by mass or more, and still more preferably 1% by mass or more. The proportion of the polymer (C) in 100% by mass of the present resin composition is preferably 10% by mass or less and more preferably 5% by mass or less. The upper and lower limits thereof may be combined in any combination. For example, 0.1% to 10% by mass is preferable, 0.5% to 5% by mass is more preferable. In a case where the proportion of the polymer (C) is equal to or larger than the above-described lower limit value, the impact strength of the molded product to be obtained is excellent. In a case where it is equal to or smaller than the above-described upper limit value, it is possible to suppress the decreases in the fluidity of the resin composition or the heat-resistant deformation temperature.

The proportion of the polycarbonate or a polycarbonate blend in 100% by mass of the present resin composition is not particularly limited and is preferably 40% by mass or more and more preferably 50% by mass or more. The proportion of the polycarbonate or a polycarbonate blend in 100% by mass of the present resin composition is preferably 99.5% by mass or less, more preferably 99% by mass or less, and still more preferably 98% by mass or less. The upper and lower limits thereof may be combined in any combination. For example, 40% to 99.5% by mass is preferable, 40% to 99% by mass is more preferable, and 50% to 98% by mass is still more preferable. In a case where the proportion of the polycarbonate or a polycarbonate blend is equal to or larger than the above-described lower limit value, it is possible to suppress changes in the fluidity of the resin composition or the heat-resistant deformation temperature. In a case where it is equal to or smaller than the above-described upper limit value, the impact strength of the molded product to be obtained is excellent.

### <<Production Method for Resin Composition>>

The resin composition can be produced by mixing the polycarbonate or a polycarbonate blend, a phosphorous-containing flame retardant, an impact modifier (the polymer (C)), and an additive as necessary. Examples of the mixing method for each material include known blending methods, which are not particularly limited. Examples thereof include a method of mixing and kneading with a tumbler, a V-type blender, a super mixer, a Nauta mixer, a Banbury mixer, a kneading roll, an extruder, or the like. An example of the production method for the resin composition according to the present invention includes a method in which the polymer (C), the pellet-shaped the polycarbonate or a polycarbonate blend, and an additive as necessary are mixed using an extruder, and the resultant mixture is extruded into a strand shape, which is subsequently cut into a pellet with a rotary cutter or the like. This method makes it possible to obtain a pellet-shaped resin composition.

### <Molded Product>

A molded product according to one aspect of the present invention (hereinafter, also denoted as “the present molded product”) contains the polymer (C) and the polycarbonate or a polycarbonate blend. The present molded product may further contain another component. Examples of the other component include known components. The present molded product preferably consists of the present resin composition.

The present molded product can be produced, for example, by molding the present resin composition. Examples of the molding method include molding methods that are used for molding a thermoplastic resin composition, for example, an injection molding method, an extrusion molding method, a blow molding method, and a calendar molding method.

The present molded product can be widely industrially used, for example, as various materials in the automobile field, the OA equipment field, the home appliance field, the electrical and electronic field, the construction field, the household and cosmetics field, and the medical product field. More specifically, it can be used as, for example, a housing for an electronic device or the like, various parts, a coating material, an automobile structural member, an automobile interior part, a light reflection plate, a building structural member, and a fixture. Still more specifically, it can be used as, for example, a housing of a personal computer, a housing of a mobile phone, a housing of a mobile information terminal, a housing of a mobile game machine, an interior/exterior member of a printer, a copying machine, or the like, a coating material of an electric conductor, an interior/exterior member of an automobile, a building exterior material, a resin window frame member, a flooring material, and a pipe member.

In some embodiments, the phosphorus-containing flame retardant comprises tetrakis(2,6-dimethylphenyl) 1,3-phenylene bisphosphate, bisphenol A bis (diphenyl phosphate) (BPADP), resorcinol bis(diphenyl phosphate) (RDP), resorcinol bis(2,6-xylyl phosphate), 4,4′-Biphenyl bis(diphenyl phosphate) (RXP), 1,4-phenylene bis(diphenyl phosphate) or combinations thereof.

In some embodiments, the composition includes a polycarbonate blend which may include PC/ABS (blend of polycarbonate and acrylonitrile-butadiene-styrene resin), PC/ASA (blend of polycarbonate and acrylonitrile-styrene-acrylate resin), PC/PBT (blend of polycarbonate and polybutylene terephthalate), PC/PET (blend of polycarbonate and polyethylene terephthalate), PC/PLA (blend of polycarbonate and polylactic acid), or combinations thereof.

In some embodiments, the composition includes a polycarbonate blend, and the polycarbonate blend includes PC/PBT or PC/PET, and the impact modifier is of the type of ethylene-methyl acrylate-glycidyl methacrylate terpolymer, or of the type of methacrylate butadiene styrene (MBS) core-shell copolymer. In some embodiments, the composition includes a polycarbonate blend which includes PC/PBT or PC/PET and the impact modifier includes an ethylene-methyl acrylate-glycidyl methacrylate terpolymer, or the impact modifier includes a methacrylate butadiene styrene (MBS) core-shell copolymer.

In some embodiments, the composition includes a polycarbonate blend which may include PC/PBT or PC/PET, and the composition includes about 5% to about 10% of the impact modifier, such as about 5%, about 6%, about 7%, about 8%, about 9%, about 10%, or any range or value contained therein.

In some embodiments, the compositions disclosed herein may be tested for flame retardancy performance and may provide V-0 performance. In some embodiments, the composition may provide V-1 performance.

In some embodiments, the compositions disclosed herein exhibits a notched izod impact strength of 350 J/m or more, 400 J/m or more, 450 J/m or more, 500 J/m or more, 550 J/m or more, 600 J/m or more, 650 J/m or more, 700 J/m or more, 750 J/m or more, 800 J/m or more, 850 J/m or more, according to ASTM D256 at 3.2 mm.

### EXAMPLES

The present invention will be specifically described below with reference to Examples. Prior to Examples, various evaluation methods and Production Examples 1-1 to 1-2 of latexes of polyorganosiloxanes will be described. Production Examples 2-1 to 2-3 are examples relating to the production and evaluation of graft copolymers (produced using the latexes of polyorganosiloxanes), and Examples 1 to 35 are examples relating to the production and evaluation of thermoplastic resin compositions. In Production Examples and Examples, “part”, “%”, and “ppm” mean “part by mass”, “% by mass”, and “ppm by mass” unless otherwise specified.

### <Solid Content>

A latex of a polyorganosiloxane having a mass w1 is dried with a hot air dryer at 180° C. for 30 minutes, a mass w2 of a residue after the drying is measured, and the solid content [%] is calculated according to the following expression.

$$Solid content [ \% ] = w 2 / w 1 \times 100$$

### <Particle Diameter>

The “polyorganosiloxane (A1) latex” or the “polymer (C) latex)” was diluted with deionized water to a concentration of solid contents of about 3% and used as a specimen, and using a CHDF 2000 type particle size distribution meter manufactured by MATEC Applied Sciences in the United States, the number average particle diameter Dn and the mass average particle diameter Dw were measured using the following conditions.
Cartridge: A dedicated particle separation capillary type cartridge (product name; C-202)
Carrier liquid: A dedicated carrier liquid (product name; 2XGR500),
Liquidity of carrier liquid: neutral
Flow rate of carrier liquid: 1.4 mL/min
Pressure of carrier liquid: 4,000 psi (2,600 kPa)
Measurement temperature: 35° C., Using amount of specimen: 0.1 mL

### (Production Method for Polymer)

### Production Example 1-1: Production of Polyorganosiloxane Latex (S-1)

2 parts of γ-methacryloyloxypropyldimethoxymethylsilane (DSMA), 2 parts of tetraethoxysilane (TEOS), and 96 parts of octamethylcyclotetrasiloxane (manufactured by Momentive Performance Materials Japan LLC, product name: TSF404) were mixed to obtain 100 parts of an organosiloxane mixture. An aqueous solution obtained by dissolving 1 part of sodium dodecylbenzenesulfonate (DBSNa) in 150 parts of deionized water was added to the organosiloxane mixture, and the resultant mixture was stirred at 10,000 rpm for 5 minutes with a homogenization mixer and then allowed to pass through a homogenizer two times at a pressure of 20 MPa to obtain a stable premixed emulsion.

After placing the obtained emulsion in a separable flask having a capacity of 5 liters, equipped with a cooling condenser, the emulsion was heated to 80° C., and a mixture of 0.20 parts of sulfuric acid and 49.8 parts of distilled water was continuously added over 3 minutes. After the polymerization reaction was carried out by maintaining for 7 hours a state of being heated to 80° C., cooling was carried out to room temperature (25° C.), and the obtained reactant was held at room temperature for 6 hours. A 5% aqueous sodium hydroxide solution was added to the obtained reactant, and the reaction solution was neutralized to a pH of 7.0 to obtain a polyorganosiloxane latex (S-1).

The solid content of the polyorganosiloxane latex (S-1) was 30.6% by mass. The number average particle diameter (Dn) was 384 nm, the mass average particle diameter (Dw) was 403 nm, and Dw/Dn was 1.05.

### Production Example 1-2: Production of Polyorganosiloxane Latex (S-2)

0.5 parts of γ-methacryloyloxypropyldimethoxymethylsilane (DSMA), 2 parts of tetraethoxysilane (TEOS), and 97.5 parts of octamethylcyclotetrasiloxane (manufactured by Shin-Etsu Silicone Co. Ltd., product name: DMC, a mixture of a 3- to 6-membered cyclic organosiloxanes) were mixed to obtain 100 parts of an organosiloxane mixture. An aqueous solution obtained by dissolving 0.68 parts of sodium dodecylbenzenesulfonate (DBSNa) and 0.68 parts of dodecylbenzenesulfonic acid (DBSH) in 150 parts of deionized water was added to the organosiloxane mixture, and the resultant mixture was stirred at 10,000 rpm for 5 minutes with a homogenization mixer and then allowed to pass through a homogenizer two times at a pressure of 20 MPa to obtain a stable premixed emulsion.

After placing the obtained emulsion in a separable flask having a capacity of 5 liters, equipped with a cooling condenser, the emulsion was heated to 80° C., maintained for 5 hours to carry out a polymerization reaction, and then cooled to room temperature (25° C.), and the obtained reactant was held at room temperature for 6 hours A 5% aqueous sodium hydroxide solution was added to the obtained reactant, and the reaction solution was neutralized to a pH of 7.0 to obtain a polyorganosiloxane latex (S-2).

The solid content of the polyorganosiloxane latex (S-2) was 33.0% by mass. The number average particle diameter (Dn) was 64 nm, the mass average particle diameter (Dw) was 248 nm, and Dw/Dn was 3.88.

The components of Production Examples 1-1 to 1-2 are shown in Table 1. The abbreviations in Table 1 are as follows.
TSF404: Octamethylcyclotetrasiloxane
DMC: A mixture of 3- to 6-membered cyclic organosiloxanes
DSMA: 7-methacryloyloxypropyldimethoxymethylsilane
TEOS: Tetraethoxysilane

TABLE 1

Production Example

| | | | 1-1 | 1-2 |
|---|---|---|---|---|
| Polyorganosiloxane | | | S-1 | S-2 |
| | TSF404 | [part] | 96 | |
| | DMC | [part] | | 97.5 |
| | DSMA | [part] | 2 | 0.5 |
| | TEOS | [part] | 2 | 2 |

### Production Example 2-1

96.4 parts (29.5 parts in terms of polymer (silicone content)) of the polyorganosiloxane latex (S-1) obtained in Production Example 1-1 was collected in a separable flask having a capacity of 5 liters, and 160 parts of deionized water, and 58.9 parts of butyl acrylate (BA), 1.8 parts of allyl methacrylate (AMA), and 0.48 parts of t-butyl hydroperoxide (tBH) were added thereto, and stirring was continued at room temperature for 1 hour to impregnate the polyorganosiloxane.

The atmosphere in the flask was substituted with nitrogen by allowing a nitrogen stream to pass through, and the liquid temperature was raised to 50° C. At a moment when the liquid temperature reached 50° C., an aqueous solution obtained by dissolving 0.001 parts of ferrous sulfate (Fe), 0.003 parts of disodium ethylenediaminetetraacetic acid (EDTA), and 0.24 parts of sodium formaldehyde sulfoxylate (SFS) in 10 parts by mass of deionized water was added thereto start a radical polymerization. After the completion of the dropwise addition, a state of a liquid temperature of 65° C. was maintained for 1 hour in order to complete the polymerization of the acrylate component, whereby a latex of a composite rubber of the polyorganosiloxane and the poly-n-butyl acrylate.

The liquid temperature of the obtained latex of the composite rubber was set to 65° C., a mixed liquid of 9.3 parts of methyl methacrylate (MMA), and 0.5 parts of butyl acrylate (BA), and 0.7 parts of t-butyl hydroperoxide (tBH) were added dropwise to the latex over 1 hour, and then the graft polymerization reaction was started. After the completion of the dropwise addition, the temperature was maintained at a temperature of 65° C. for 1 hour and then cooled to room temperature to obtain a latex of a polyorganosiloxane-containing graft copolymer (G-1).

500 parts of an aqueous solution having a calcium acetate concentration of 5% by mass was heated to 60° C., and 340 parts of the latex of the graft copolymer (G-1) was gradually added dropwise thereto and solidified while stirring. The obtained graft copolymer (G-1) was filtered, washed, dehydrated, and then dried to obtain a graft copolymer (G-1).

### Production Example 2-2

242 parts (80 parts in terms of polymer) of the polyorganosiloxane latex (S-2) obtained in Production Example 1-2 was collected in a separable flask having a capacity of 5 liters, and 60 parts of deionized water, and 8.82 parts of butyl acrylate (BA), 0.18 parts of allyl methacrylate (AMA), and 0.16 parts of cumene hydroperoxide (CB) were added thereto, and stirring was continued at room temperature for 1 hour to impregnate the polyorganosiloxane.

The atmosphere in the flask was substituted with nitrogen by allowing a nitrogen stream to pass through, and the liquid temperature was raised to 50° C. At a moment when the liquid temperature reached 50° C., an aqueous solution obtained by dissolving 0.001 parts of ferrous sulfate (Fe), 0.003 parts of disodium ethylenediaminetetraacetic acid (EDTA), and 0.24 parts of sodium formaldehyde sulfoxylate (SFS) in 10 parts by mass of deionized water was added thereto start a radical polymerization. After the completion of the dropwise addition, a state of a liquid temperature of 65° C. was maintained for 1 hour in order to complete the polymerization of the acrylate component, whereby a latex of a composite rubber of the polyorganosiloxane and the poly-n-butyl acrylate.

The liquid temperature of the obtained latex of the composite rubber was set to 65° C., a mixed liquid of 11 parts of methyl methacrylate (MMA), and 0.24 parts of cumene hydroperoxide (CB) were added dropwise to the latex over 1 hour, and then the graft polymerization reaction was started. After the completion of the dropwise addition, the temperature was maintained at a temperature of 65° C. for 1 hour and then cooled to room temperature to obtain a latex of a polyorganosiloxane-containing graft copolymer (G-2).

A powder of a graft copolymers (G-2) were obtained in the same manner as in Production Example 2-1.

### Production Example 2-3

30 parts (9.9 parts in terms of polymer) of the polyorganosiloxane latex (S-2) obtained in Production Example 1-2 was collected in a separable flask having a capacity of 5 liters, and 230 parts of deionized water, and 0.4 parts of sodiumpoly(oxyethylene)dodecylethersulfate, and 77.5 parts of butyl acrylate (BA), 1.6 parts of allyl methacrylate (AMA), and 0.02 parts of t-butyl hydroperoxide (tBH) were added thereto, and stirring was continued at room temperature for 1 hour to impregnate the polyorganosiloxane.

The atmosphere in the flask was substituted with nitrogen by allowing a nitrogen stream to pass through, and the liquid temperature was raised to 50° C. At a moment when the liquid temperature reached 50° C., an aqueous solution obtained by dissolving 0.001 parts of ferrous sulfate (Fe), 0.003 parts of disodium ethylenediaminetetraacetic acid (EDTA), and 0.24 parts of sodium formaldehyde sulfoxylate (SFS) in 10 parts by mass of deionized water was added thereto start a radical polymerization. After the completion of the dropwise addition, a state of a liquid temperature of 65° C. was maintained for 1 hour in order to complete the polymerization of the acrylate component, whereby a latex of a composite rubber of the polyorganosiloxane and the poly-n-butyl acrylate.

The liquid temperature of the obtained latex of the composite rubber was set to 65° C., a mixed liquid of 11 parts of methyl methacrylate (MMA), and 0.04 parts of t-butyl hydroperoxide (tBH) were added dropwise to the latex over 1 hour, and then the graft polymerization reaction was started. After the completion of the dropwise addition, the temperature was maintained at a temperature of 65° C. for 1 hour and then cooled to room temperature to obtain a latex of a polyorganosiloxane-containing graft copolymer (G-3).

A powder of a graft copolymers (G-3) were obtained in the same manner as in Production Example 2-1.

TABLE 2

| | | | Production Example | | |
|---|---|---|---|---|---|
| | | | 2-1 | 2-2 | 2-3 |
| Graft copolymer (G) | | | G-1 | G-2 | G-3 |
| Rubber | Polyorganosiloxane | Kind | S-1 | S-2 | S-2 |
| part | (S) | Amount | 29.5 | 80 | 9.9 |
| | | (silicone | | | |
| | | content) | | | |
| | | [part] | | | |
| | Monomer for | BA | 58.9 | 8.82 | 77.5 |
| | composite rubber | [part] | | | |
| | | AMA | 1.8 | 0.18 | 1.6 |
| | | [part] | | | |

| | | | |
|---|---|---|---|
| MMA [part] | 9.3 | 11 | 11 |
| BA [part] | 0.5 | 0 | 0 |

The abbreviations in Table 2 are as follows.
BA: n-butyl acrylate
AMA: Allyl methacrylate
MMA: Methyl methacrylate

### Examples 1 to 7

Impact Modifier 1 (graft copolymer (G-1)) was compounded into the blends of PC and polyphosphonate as shown in Table 3. As expected for an impact modifier, the notched izod (NI) at 3.2 mm (according to ASTM D256) increased with the increasing loading of Impact Modifier 1, and at 2%, the NI has reached 100% ductile break. Unexpectedly for an impact modifier, the flame retardancy of the blends at 1.6 mm as measured according to UL-94 has also been improved, i.e. the after-burn time became shorter with the increasing loading of Impact Modifier 1 up to 2%, as can be understood from the results of t max and t total. Above this loading (e.g. 3%) the NI has kept at 100% ductile break but the after-burn time got longer again. Another important trend in Table 3 is that at a given level of Impact Modifier 1 (i.e. 2%), when the Nofia loading was reduced from 32% to 24% to 16%, the drips increased and the after-burn time lengthened. And the UL-94 rating at 1.6 mm changed from V-0 to V-1 and then V-2 respectively. This indicates that it is the combination of polyphosphonate and Impact Modifier 1 with the right loadings that are responsible for the extraordinary flame retardant performance. All formulations in Table 3 were compounded at low temperatures with actual melt temperature at the die no higher than 225° C. and all ingredients were used as is (i.e., undried) before compounding.

TABLE 3

| Undried before | Example | Example | Example | Example | Example | Example | Example |
|---|---|---|---|---|---|---|---|
| compounding | 1 | 2 | 3 | 4 | 5 | 6 | 7 |
| Polycarbonate, PC60 | 68% | 68% | 67% | 66% | 65% | 74% | 82% |
| Nofia C06010-EX | 32% | 32% | 32% | 32% | 32% | 24% | 16% |
| Impact modifier 1 | 0% | 0.50% | 1% | 2% | 3% | 2% | 2% |
| Total | 100% | 100% | 100% | 100% | 100% | 100% | 100% |
| P content | 2.1% | 2.1% | 2.1% | 2.1% | 2.1% | 1.6% | 1.0% |
| Compounding | 200/225/225/225/220/220/215/215 | | | | | | |
| temperature set, ° C. | | | | | | | |
| NI at 3.2 mm, Jim | 90 | 130 | 360 | 860 | 830 | 800 | 780 |
| UL-94 at 1.6 mm | V-0 | V-0 | V-0 | V-0 | V-0 | V-1 | V-2 |
| t max, sec | 6 | 7 | 4 | 3 | 6 | 13 | 12 |
| t total, sec | 28 | 25 | 21 | 14 | 29 | 49 | 51 |
| # drips/flaming drips | 0/0 | 0/0 | 0/0 | 0/0 | 0/0 | 1/0 | 4/3 |

Note:
“Polycarbonate, PC60” is ColorFast (registered trademark) PC60 supplied by LTL Color Compounds
“Nofia CO6010-EX” is polyphosphonate-based flame retardant supplied by FRX polymers, Inc. with phosphorous content about 6.5%.

### Examples 8 to 10

Lotader AX8900, Impact Modifier 1 (graft copolymer (G-1)) and Impact Modifier 2 (graft copolymer (G-2)) were compounded into the blends of PC and polyphosphonate as shown in Table 4. In this experiment, all the formulation shows the UL-94 rating at 1.6 mm to V-0 and shows the UL-94 rating at 0.8 mm to V-2. Unexpectedly, for the formulation in Table 4 containing Impact Modifier 1 and 2, the drips are less than Lotader AX8900. Impact Modifier 2 had the least amount of drips.

TABLE 4

| Undried before | | | |
|---|---|---|---|
| compounding | Example 8 | Example 9 | Example 10 |
| PC, Lexan 141R | 66% | 66% | 66% |
| Nofia C06010-EX | 32% | 32% | 32% |
| Lotader AX8900 | 2% | | |
| Impact modifier 1 | | 2% | |
| Impact modifier 2 | | | 2% |
| Total | 100% | 100% | 100% |
| P content | 2.1% | 2.1% | 2.1% |
| Compounding | 200/265/265/265/260/260/260/260 | | |
| temperature set, ° C. | | | |
| NI@3.2 mm, Jim | 751 | 728 | 692 |
| UL-94 @1.6 mm | V-0 | V-0 | V-0 |
| t max, sec | 7 | 4 | 3 |
| t total, sec | 27 | 20 | 15 |
| # drip/flaming drips | 0/0 | 0/0 | 0/0 |
| #pass V-0/total test | 5/5 | 5/5 | 5/5 |
| UL-94 @0.8 mm | V-2 | V-2 | V-2 |
| t max, sec | 5 | 4 | 4 |
| t total, sec | 28 | 22 | 18 |
| # drip/flaming drips | 10/5 | 7/5 | 5/3 |
| #pass V-0/total test | 2/5 | 1/5 | 2/5 |

Note:
“PC, Lexan 141R” is polycarbonate supplied by SABIC Innovative Plastics.
“Lotader AX8900” is an ethylene-methyl acrylate-glycidyl methacrylate terpolymer Supplied by SK Functional Polymer.

### Examples 11 to 14

Table 5 shows another example of such unexpected effect by Impact Modifier 1. In this experiment, all the formulations except the last one had drips and some of them were flaming drips, thus only V-2 rating. For the last formulation in Table 5 containing Impact Modifier 1, the drips suddenly disappeared, whether non-flaming drips or flaming drips, and the after-burn time was also significantly shorter. All the formulations in Table 5 were compounded at higher temperatures than Table 3 with actual melt temperature at the die around 276-279° C. and all the ingredients were dried before compounding. It appears that Impact Modifier 1 reduced dripping and shortened the after-burn time compared to the blends of PC and polyphosphonate without Impact Modifier 1 made under the same conditions.

TABLE 5

| Dried before compounding | Example 11 | Example 12 | Example 13 | Example 14 |
|---|---|---|---|---|
| Polycarbonate, PC60 | 44% | 65% | 68% | 62% |
| Nofia C06010-EX | 56% | 32% | 24% | 24% |
| Impact Modifier 1 | | | | 1% |
| TiO₂ | | | | 5% |
| Phosphazene SPB-100 | | 3% | 3% | 3% |
| Sol-DP | | | 5% | 5% |
| Total | 100% | 100% | 100% | 100% |
| P content | 3.6% | 2.5% | 2.5% | 2.5% |
| Compounding temperature | 200/270/270/270/270/270/270/270 | | | |
| set, ° C. | | | | |
| NI at 3.2 mm, J/m | 74 | 87 | 58 | 99 |
| UL-94 atl.6 mm | V-2 | V-2 | V-2 | V-0 |
| t max, sec | 3 | 5 | 5 | 2 |
| t total, sec | 18 | 24 | 29 | 16 |
| #drip/flaming drip | 4/1 | 3/2 | 5/2 | 0/0 |
| # pass V-0/total tested | 5/6 | 5/6 | 4/6 | 5/5 |

Note:
“Phosphazene SPB-100” is poly(bis(phenoxy) phosphazene) supplied by Otsuka Chemical Co., Ltd.

### Examples 15 to 18

Table 6 shows the flame retardant polycarbonate (PC) formulations containing PTFE. Again, it demonstrates that Impact Modifier 1 improves the NI. Sometimes such improvement was not seen with the room temperature conditioned samples but revealed after samples immersed in 70° C. water for 7 days. At 5% loading, however, Impact Modifier 1 had negative impact on flame retardancy giving prolonged after-burn time. Together with what already shown in Table 3, it is clear there exists a maximum level of Impact Modifier 1 beyond which it starts to negatively impact flame retardancy. Such level of Impact Modifier 1 may be less than 5% or less 3% for the formulations evaluated.

TABLE 6

| | Example | Example | Example | Example |
|---|---|---|---|---|
| | 15 | 16 | 17 | 18 |
| Polycarbonate, PC100 | 99.6% | 94.6% | 89.6% | 84.6% |
| TiO₂ | | 5.0% | 5.0% | 5.0% |
| Impact Modifier 1 | | | 5.0% | 5.0% |
| C06010-EX, 220927-1 | | | | 5.0% |
| PTFE 6C powder | 0.4% | 0.4% | 0.4% | 0.4% |
| Total | 100.0% | 100.0% | 100.0% | 100.0% |
| NI at3.2 mm, Jim | | | | |
| room temperature conditioned | 75 | 710 | 685 | 665 |
| 70° C./7 day water immersion | 25 | 60 | 460 | 470 |
| % NI retention | 33% | 8% | 67% | 71% |
| UL-94 at1.6 mm | V-0 | V-0 | NR | V-0 |
| t max, seconds | 4 | 3 | 53 | |
| t total, seconds | 19 | 15 | 112 | 48 |
| #driping/flaming drips | 0/0 | 0/0 | 0/0 | 0/0 |

Note:
“Polycarbonate, PC100” is ColorFast (registered trademark) PC100 supplied by LTL Color Compounds
“PTFE 6C powder” is Teflon (registered trademark) PTFE 6C X supplied by Chemours

### Examples 19 to 20

Table 7 shows the effect of Impact Modifier 1 in formulations of flame retardant PC/ABS based on polyphosphonate. Again, with 10% of Impact Modifier 1, NI has almost been doubled while flame retardancy is no change, or slightly better.

TABLE 7

| | Example | Example |
|---|---|---|
| | 19 | 20 |
| PC/ABS (recycled) | 74.55% | 73.55% |
| Nofia C06000 | 25.00% | 25.00% |
| Impact Modifier 1 | | 1.00% |
| PTFE, 6C | 0.45% | 0.45% |
| Total | 100% | 100% |
| Notched izod at 3.2 mm | 150 | 280 |
| UL-94at1.6 mm | V-0 | V-0 |
| t max, sec | 6 | 4 |
| t, total, sec | 25 | 20 |
| # total drip/flaming drip | 0/0 | 0/0 |

Note:
“Nofia CO6000” is a poly(phosphonate-co-carbonate)-based flame retardant supplied by FRX Polymers, Inc. with phosphorus content about 6.5%.
“PC/ABS (recycled)” is a recycled PC/ABS blend (proportion of ABS: 15 to 20% by mass) supplied by Lavergne

### Examples 21 to 22

Table 8 shows the comparison of two silicone-acrylic-based rubber impact modifiers, Impact Modifier 1 and Impact Modifier 3 (graft copolymer (G-3)). According to the manufacturer, Impact Modifier 1 has higher silicone content than Impact Modifier 3. Based on the after-burn time, Impact Modifier 1 based formulation is better in FR when compared to Impact Modifier 3 at same loading, which can be due to the higher silicone content in Impact Modifier 1, without wishing to be bound by theory. Silicone content in the impact modifier is important for its effect on flame retardancy.

TABLE 8

| | Example | Example |
|---|---|---|
| | 21 | 22 |
| Polycarbonate, PC60 | 66% | 66% |
| Nofia C06010-EX | 32% | 32% |
| Impact Modifier 1 | 2% | |
| Impact Modifier 3 | | 2% |
| Total | 100% | 100% |
| P content | 2.1% | 2.1% |
| NI at3.2 mm, Jim | 860 | 830 |
| UL-94 at1.6 mm | V-0 | V-0, |
| t max, sec | 3 | |
| t total, sec | 14 | 38 |
| # drips/flaming drips | 0/0 | 0/0 |

### Examples 23 to 32

Table 9 shows the PTFE free formulations for PC/PBT blends based on Nofia HM7000. Three different types of impact modifiers were compared in the DOE (Design of Experiments). At loading of 10%, Lotader AX8900 appears to be the best impact modifier in that it improved the NI to 100% ductile break, eliminated dripping and increased the UL-94 FR performance to V-0 at both 1.6 mm and 0.8 mm, while the control without the impact modifier was V-2 at 1.6 mm. Paraloid EXL-2690 is the second best, which increased the NI to 100% ductile break, eliminated dripping, achieved V-0 at 1.6 mm, but only V-1 at 0.8 mm. Impact Modifier 1, which worked very well for FR PC, did not appear to be suitable for PC/PBT. At 2% of loading, Impact Modifier 1 improved the FR to V-0 at 1.6 mm, but did not give enough improvement for N. When the loading was further increased, N was increased, but the FR became worse. There was not a loading found for Impact Modifier 1 that gave both good NI and FR for PC/PBT. All the formulations in Table 9 were compounded after PC, PBT and Nofia were dried.

TABLE 9

| dried before | Ex. | Ex. | Ex. | Ex. | Ex. | Ex. | Ex. | Ex. | Ex. | Ex. |
|---|---|---|---|---|---|---|---|---|---|---|
| compounding | 23 | 24 | 25 | 26 | 27 | 28 | 29 | 30 | 31 | 32 |
| PC, Lexan 141R | 45% | 43.00% | 41.50% | 40% | 35% | 35% | 34.50% | 34.00% | 35% | 34.00% |
| PBT, Ultradur 4520 | 30% | 30.0% | 30.0% | 30% | 30% | 30% | 30.0% | 30.0% | 30% | 30.0% |
| Nofia, HM7000 | 25% | 25.0% | 25.0% | 25% | 25% | 25% | 25.0% | 25.0% | 25% | 25.0% |
| Impact modifier 1 | | 2.0% | 3.5% | 5% | 10% | | 0.50% | 1.0% | | 1% |
| Lotader AX8900 | | | | | | 10% | 10% | 10% | | |
| Paraloid EXL-2690 | | | | | | | | | 10% | 10% |
| Total | 100% | 100% | 100% | 100% | 100% | 100% | 100% | 100% | 100% | 100% |
| Notched Izod at | 60 | 90 | 145 | 700 | 730 | 685 | 670 | 700 | 635 | 725 |
| 3.2 mm, Jim | | | | | | | | | | |
| Compounding | 200/235/235/235/230/230/225/225 | | | | | | | | | |
| temp, ° C. | | | | | | | | | | |
| UL-94 at1.6 mm | V-2 | V-0 | V-2 | V-2 | V-1 | V-0 | V-0 | V-0 | V-0 | V-0 |
| | | | | | | | | | | (V-1) |
| t max, sec | 1 | 3 | 25 | 36 | 20 | 5 | 8 | 6 | | 8 |
| | | | | | | | | | | (14) |
| t total, sec | 10 | 15 | 51 | 66 | 100 | 18 | 31 | 30 | 26 | 39 |
| | | | | | | | | | | (57) |
| # drip/flaming drips | 16/3 | 1/0 | 9/3 | 8/3 | 2/0 | 0/0 | 0/0 | 0/0 | 0/0 | 0/0 |
| #pass V-0/total test | 3/5 | 5/5 | 0/5 | 2/5 | 1/5 | 5/5 | 5/5 | 5/5 | 5/5 | 5/6 |
| UL-94 at0.8 mm | | | | | | V-0 | V-1 | V-1 | V-1 | |
| t max, sec | | | | | | 7 | 17 | 17 | 15 | |
| t total, sec | | | | | | 30 | 53 | 74 | 73 | |
| # drip/flaming drips | | | | | | 0/0 | 0/0 | 0/0 | 0/0 | |
| #pass V-0/total test | | | | | | 5/5 | 3/5 | 2/5 | 0/5 | |

Note:
“PBT, Ultradur 4520” is polybutylene terephthalate supplied by BASF.
“Paraloid EXL-2690” is methyl methacrylate-butadiene-styrene (MBS) core-shell copolymer supplied by Dow Chemical.
“Nofia HM7000” is a polyphosphonate-based flame retardant supplied by FRX Polymers, Inc, with phosphorus content of about 10.6%.

### Examples 33 to 35

In Table 10, two formulations based on Lotader AX8900 were compared with ingredients either dried or undried before compounding. As it can be seen, 100% ductile break and V-0 at 1.6 mm were still maintained without drying. For 0.8 mm, 5 out 6 specimens were V-0 but there was one that had after burning time longer than 10 seconds, but all had no dripping. Nofia C06010-EX has higher hydrolytic stability and will be tried next for compounding without drying. In addition, Nofia polymers are silo-dried before packaging. If kept from re-absorbing moisture before compounding, it is possible to better maintain NI and FR without drying

AX8900 has glycidyl methacrylate on it that could provide reactivity with OH group to increase the compatibility between PC, PBT, PET and Nofia, leading to improved dispersion during melt mixing. For a polymeric flame-retardant additive like polyphosphonate, optimization of its compatibility with the resin matrix is crucial for all the resulting properties, including flame retardancy. Therefore, other ideas will also be explored to further improve compatibilization. For example, C06010-EX is totally miscible with PC, thus will be more compatible in PC alloys. Transesterification reaction could also be further enhanced with addition of catalyst to increase compatibility.

### Examples 36 to 38

Table 11 shows PTFE free flame-retardant PC/PET blend based on Nofia HM7000 with a control (i.e. without impact modifier) and two examples with AX8900 and EXL-2690. Again, significant improvements in impact property and flame retardancy were seen with the addition of both impact modifiers. The improvement in flame retardancy is even more dramatic at lower thickness of 0.8 mm where flaming drips that igniting the cotton completely disappeared with the impact modifier while the control had many flaming drips. In PC/PET blend, it appears that EXL-2690 performed somewhat better in flame retardancy than AX8900.

Experiments are underway for PC and other PC alloys including PC/ABS, PC/PLA, and others, which are expected to also from the compositions and methods disclosed herein.

TABLE 10

| | Example 33 | Example 34 | Example 35 |
|---|---|---|---|
| Before compounding | dried | dried | undried |
| PC, Lexan 141R | 35% | 35% | 35% |
| PBT Ultradur 4520 | 30% | 30% | 30% |
| Nofia HM7000 | 25% | 25% | 25% |
| Lotader AX8900 | 10% | 10% | 10% |
| Total | 100% | 100% | 100% |
| Compounding temp, ° C. | 200/235/235/235/230/230/225/225 | | |
| Throughput, rpm | 10 kg/hr, 100 rpm | | |
| Torque,% | 46 | 47 | 45 |
| Notched Izod at 3.2 mm, J/m | 685 | 655 | 600 |
| UL-94 at 1.6 mm | V-0 | V-0 | V-0 |
| t max, sec | 5 | 5 | 8 |
| t total, sec | 18 | 22 | 25 |
| # drip/flaming drips | 0/0 | 0/0 | 0/0 |
| #pass V-0/total test | 5/5 | 5/5 | 5/5 |
| UL-94 at 0.8 mm | V-0 | V-0 | V-0 (V-1) |
| t max, sec | 7 | 7 | 18 |
| t total, sec | 30 | 27 | 49 |
| # drip/flaming drips | 0/0 | 0/0 | 0/0 |
| #pass V-0/total test | 5/5 | 5/5 | 5/6 |

TABLE 11

| Dried before compounding | Example 36 | Example 37 | Example 38 |
|---|---|---|---|
| PC, Lexan 141R | 50.0% | 40.0% | 40.0% |
| PET, Auriga 7800 | 30% | 30% | 30% |
| Nofia HM7000 | 20% | 20% | 20% |
| Lotader AX8900 | | 10% | |
| Paraloid EXL-2690 | | | 10% |
| Total | 100% | 100% | 100% |
| NI at3.2 mm, Jim | 60 | 870 | 760 |
| UL-94 at1.6 mm | V-0 (V-2) | V-0 (V-1) | V-0 |
| t max, sec | 2 | 19 | 8 |
| t total, sec | 19 | 48 | 32 |
| # drip/flaming drips | 1/1 | 0/0 | 0/0 |
| #pass V-0/total test | 5/6 | 6/7 | 5/5 |
| UL-94 at0.8 mm | V-2 | V-0 (V-1) | V-0 |
| t max, sec | 2 | 12 | 9 |
| t total, sec | 13 | 41 | 48 |
| # drip/flaming drips | 13/6 | 0/0 | 1/0 |
| #pass V-0/total test | 1/5 | 5/6 | 5/5 |

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

As used herein, “flame retardant” refers to any compound that inhibits, prevents, or reduces the spread of fire.

The terms “flame retardant,” “flame resistant,” “fire resistant,” or “fire resistance,” as used herein, mean that the composition exhibits a limiting oxygen index (LOI) of at least 27. “Flame retardant,” “flame resistant,” “fire resistant,” or “fire resistance” may also refer to the flame reference standard ASTM D6413-99 for textile compositions, flame persistent test NF P 92-504, and similar standards for flame resistant fibers and textiles. Fire resistance may also be tested by measuring the after-burning time in accordance with the UL test (Subject 94). In this test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the maximum burning time after removal of the ignition flame should not exceed 10 seconds and the total burning time (t1+t2) for five tested specimens should not exceed 50 seconds. None of the test specimens should release any drips which ignite absorbent cotton wool.

UL-94 V-1: the maximum burning time after removal of the ignition flame should not exceed 30 seconds and the total burning time (t1+t2) for five tested specimens should not exceed 250 seconds. None of the test specimens should release any drips which ignite absorbent cotton wool.

UL-94 V-2: the maximum burning time after removal of the ignition flame should not exceed 30 seconds and the total burning time (t1+t2) for five tested specimens should not exceed 250 seconds. The test specimens may release flaming particles, which ignite absorbent cotton wool.

The term “toughness,” as used herein, is meant to imply that the material is resistant to breaking or fracturing when stressed or impacted. There are a variety of standardized tests available to determine the toughness of a material. Generally, toughness is determined qualitatively using a film or a molded specimen.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 cells refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

### INDUSTRIAL APPLICABILITY

The present invention can provide a flame-retardant composition that shows excellent mechanical properties and flame retardancy that are balanced at a high level even without anti-dripping agents such as PTFE. Therefore, the present invention has industrial applicability.

1. A flame-retardant composition comprising:
polycarbonate or a polycarbonate blend, a phosphorous-containing flame retardant, and an impact modifier,
wherein the phosphorus-containing flame retardant comprises polyphosphonate, poly(phosphonate-co-carbonate), or combinations thereof,
wherein the impact modifier comprises polyorganosiloxane-containing polymer, and
The composition according to claim 1, wherein the composition is free of polytetrafluoroethylene (PTFE).
The composition according to claim 1, wherein the composition further comprises at least one additive selected from the group consisting of pigments, stabilizers, fillers, processing aids, and additional flame retardant compounds different from phosphorous-containing flame retardant.

4. The composition according to claim 1, wherein the composition comprises the polycarbonate, and the impact modifier is of core-shell type and has a silicone content of 10% by mass or more.

5. The composition according to claim 4, wherein the impact modifier has a silicone content of 40% by mass or more.

6. The composition according to claim 1, wherein the composition comprises the polycarbonate and the impact modifier is a polymer having a composite body and a graft part, the composite body comprises a polyorganosiloxane and a first vinyl polymer, and the graft part comprises a second vinyl polymer.

7. The composition according to claim 6, wherein the second vinyl polymer comprises a constitutional unit derived from a (meth)acrylate monomer.

8. The composition according to claim 1, wherein the composition comprises the polycarbonate and 0.5% by mass to 10% by mass of the impact modifier.

9. The composition according to claim 1, wherein the composition comprises the polycarbonate and 0.5% by mass to 5% by mass of the impact modifier.

10. The composition according to claim 1, wherein the phosphorus-containing flame retardant comprises tetrakis(2,6-dimethylphenyl) 1,3-phenylene bisphosphate, bisphenol A bis (diphenyl phosphate) (BPADP), resorcinol bis(diphenyl phosphate) (RDP), resorcinol bis(2,6-xylyl phosphate), 4,4′-Biphenyl bis(diphenyl phosphate) (RXP), 1,4-phenylene bis(diphenyl phosphate), poly(bis(phenoxy) phosphazene, or combinations thereof.

11. The composition according to claim 1, wherein the proportion of the phosphorous-containing flame retardant in 100% by mass of the composition is more than 25% by mass.

12. The composition according to claim 1, wherein the composition comprises polycarbonate blend, and the polycarbonate blend comprises PC/ABS, PC/ASA, PC/PBT, PC/PET, PC/PLA, or combinations thereof
